(19) United States
(12) Patent Application Publication
(10) Pub. No.: US 2023/0160713 A1
(43) Pub. Date: May 25, 2023

(54) METHOD, APPARATUS AND COMPUTER PROGRAM PRODUCT FOR IDENTIFYING WORK ZONES WITHIN A MAP

(71) Applicant: HERE GLOBAL B.V., Eindhoven (NL)

(72) Inventors: Jingwei XU, Buffalo Grove, IL (US); Yuxin GUAN, Chicago, IL (US); Bruce BERNHARDT, Wauconda, IL (US); Leon STENNETH, Chicago, IL (US)

(21) Appl. No.: 17/455,792

(22) Filed: Nov. 19, 2021

(51) Int. Cl. G01C 21/36; G01C 21/34; B60W 60/00

(52) U.S. Cl. CPC G01C 21/367; G01C 21/3461; B60W 60/001; B60W 2552/53

(57) ABSTRACT

Embodiments described herein may provide a method for aggregating probe data to detect a road work event and generating, from the road work event, a work zone map overlay to inform navigational systems and autonomous vehicles. Methods may include: receiving probe data from a plurality of probe apparatuses traveling within a road network; identifying, from the probe data, a road work event within the road network; determining, from the road work event and the probe data, a work zone; generating a map overlay including the work zone, where the map overlay is independent from map data of the road network; providing the map overlay to at least one vehicle for use in combination with the map data of the road network; and providing for at least one of navigational assistance or at least semi-autonomous vehicle control based on the map overlay of the map data of the road network.

### TECHNOLOGICAL FIELD

An example embodiment of the present invention relates generally to providing an indication of work zones within a map, and more particularly, to a method, apparatus and computer program product for aggregating probe data to detect a road work event and generating, from the road work event, a work zone map overlay to inform navigational systems and autonomous vehicles.

### BACKGROUND

Digital maps provide a detailed view of a road network and enable users to navigate among the road network with relative ease. Further, dynamic information such as traffic can provide additional details that help drivers navigate the road network efficiently. Beyond traffic, there are other factors that influence travel within a road network. Various hazard identification systems exist to identify potentially hazardous conditions such as road work conditions in a road network. Municipalities may publish road work events that can be used by traffic services and map data services to caution drivers of road work. These road work events generally involve little detail and often include tentative, planned schedules where the schedules may not account for various events that may impact scheduling.

Road work details within map data may not be temporally relevant, and may lag actual events due to the refresh rate of map data. Further, the dynamic nature of road work events presents challenges to map data service providers.

### BRIEF SUMMARY

A method, apparatus, and computer program product are therefore provided for aggregating probe data to detect a road work event and generating, from the road work event, a work zone map overlay to inform navigational systems and autonomous vehicles. An apparatus may be provided including at least one processor and at least one non-transitory memory including computer program code instructions, the computer program code instructions may be configured to, when executed, cause the apparatus to at least: receive probe data from a plurality of probe apparatuses traveling within a road network; identify, from the probe data, a road work event within the road network; determine, from the road work event and the probe data, a work zone; generate a map overlay including the work zone, where the map overlay is independent from map data of the road network; provide the map overlay to at least one vehicle for use in combination with the map data of the road network; and provide for at least one of navigational assistance or at least semi-autonomous vehicle control based on the map overlay of the map data of the road network.

The map overlay of example embodiments is dynamic, with the work zone indicating an area in which at least one change to road segment information relative to the map data is present. The at least one change to road segment information relative to the map data includes a change to at least one of: a number of lanes available on a road segment, a speed limit of a road segment, or lane markings of a road segment. The work zone of the map overlay includes, in certain embodiments, a time to live, where the time to live is determined based on an event type of the word network. The event type of the road work event comprises at least one of: a vehicle accident, road surface improvements, or infrastructure changes.

According to some embodiments, the apparatus is further caused to determine, from the probe data and from map data, one or more affected driving lanes associated with the work zone. Causing the apparatus to provide for at least one of navigational assistance or at least semi-autonomous vehicle control includes, in some embodiments, causing the apparatus to provide at least semi-autonomous vehicle control, where the apparatus is further caused to identify, from the probe data and map data, map attributes associated with the work zone affecting at least semi-autonomous vehicle control. The apparatus of certain embodiments is further caused to determine, based on the map attributes associated with the work zone affecting at least semi-autonomous vehicle control, that autonomous vehicle control is not recommended, and cede vehicle control to an operator in response to the apparatus determining that autonomous vehicle control is not recommended.

Embodiments provided herein include a computer program product including at least one non-transitory computer-readable storage medium having computer-executable program code instructions stored therein, the computer-executable program code instructions including program code instructions to: receive probe data from a plurality of probe apparatuses traveling within a road network; identify, from the probe data, a road work event within the road network; determine, from the road work event and the probe data, a work zone; generate a map overlay including the work zone, where the map overlay is independent from map data of the road network; provide the map overlay to at least one vehicle for use in combination with the map data of the road network; and provide for at least one of navigational assistance or at least semi-autonomous vehicle control based on the map overlay of the map data of the road network.

The map overlay of example embodiments is dynamic, with the work zone indicating an area in which at least one change to road segment information relative to the map data is present. The at least one change to road segment information relative to the map data includes a change to at least one of: a number of lanes available on a road segment, a speed limit of a road segment, or lane markings of a road segment. The work zone of the map overlay includes, in certain embodiments, a time to live, where the time to live is determined based on an event type of the word network. The event type of the road work event comprises at least one of: a vehicle accident, road surface improvements, or infrastructure changes.

According to some embodiments, the computer program product further includes program code instructions to determine, from the probe data and from map data, one or more affected driving lanes associated with the work zone. The program code instructions to provide for at least one of navigational assistance or at least semi-autonomous vehicle control include, in some embodiments, program code instructions to provide at least semi-autonomous vehicle control, where the computer program product further includes program code instructions to identify, from the probe data and map data, map attributes associated with the work zone affecting at least semi-autonomous vehicle control. The computer program product of certain embodiments further includes program code instructions to determine, based on the map attributes associated with the work zone affecting at least semi-autonomous vehicle control, that autonomous vehicle control is not recommended, and cede vehicle control to an operator in response to the program code instructions determining that autonomous vehicle control is not recommended.

Embodiments provided herein include a method including: receiving probe data from a plurality of probe apparatuses traveling within a road network; identifying, from the probe data, a road work event within the road network; determining, from the road work event and the probe data, a work zone; generating a map overlay including the work zone, where the map overlay is independent from map data of the road network; providing the map overlay to at least one vehicle for use in combination with the map data of the road network; and providing for at least one of navigational assistance or at least semi-autonomous vehicle control based on the map overlay of the map data of the road network.

The map overlay of example embodiments is dynamic, with the work zone indicating an area in which at least one change to road segment information relative to the map data is present. The at least one change to road segment information relative to the map data includes a change to at least one of: a number of lanes available on a road segment, a speed limit of a road segment, or lane markings of a road segment. The work zone of the map overlay includes, in certain embodiments, a time to live, where the time to live is determined based on an event type of the word network. The event type of the road work event comprises at least one of: a vehicle accident, road surface improvements, or infrastructure changes.

According to some embodiments, the method further includes determining, from the probe data and from map data, one or more affected driving lanes associated with the work zone. Providing for at least one of navigational assistance or at least semi-autonomous vehicle control includes, in some embodiments, providing at least semi-autonomous vehicle control, where the method further includes identifying, from the probe data and map data, map attributes associated with the work zone affecting at least semi-autonomous vehicle control. The method of certain embodiments further includes determining, based on the map attributes associated with the work zone affecting at least semi-autonomous vehicle control, that autonomous vehicle control is not recommended, and ceding vehicle control to an operator in response to determining that autonomous vehicle control is not recommended. The method of an example embodiment further includes deriving a road detour event based on the work zone to support at least one of navigational assistance or at least semi-autonomous vehicle control.

Embodiments provided herein include an apparatus including: means for receiving probe data from a plurality of probe apparatuses traveling within a road network; means for identifying, from the probe data, a road work event within the road network; means for determining, from the road work event and the probe data, a work zone; means for generating a map overlay including the work zone, where the map overlay is independent from map data of the road network; means for providing the map overlay to at least one vehicle for use in combination with the map data of the road network; and means for providing for at least one of navigational assistance or at least semi-autonomous vehicle control based on the map overlay of the map data of the road network.

The map overlay of example embodiments is dynamic, with the work zone indicating an area in which at least one change to road segment information relative to the map data is present. The at least one change to road segment information relative to the map data includes a change to at least one of: a number of lanes available on a road segment, a speed limit of a road segment, or lane markings of a road segment. The work zone of the map overlay includes, in certain embodiments, a time to live, where the time to live is determined based on an event type of the word network. The event type of the road work event comprises at least one of: a vehicle accident, road surface improvements, or infrastructure changes.

According to some embodiments, the apparatus further includes means for determining, from the probe data and from map data, one or more affected driving lanes associated with the work zone. The means for providing for at least one of navigational assistance or at least semi-autonomous vehicle control includes, in some embodiments, means for providing at least semi-autonomous vehicle control, where the apparatus further includes means for identifying, from the probe data and map data, map attributes associated with the work zone affecting at least semi-autonomous vehicle control. The apparatus of certain embodiments further includes means for determining, based on the map attributes associated with the work zone affecting at least semi-autonomous vehicle control, that autonomous vehicle control is not recommended, and means for ceding vehicle control to an operator in response to determining that autonomous vehicle control is not recommended.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for generating a dynamic work zone map layer from a plurality of information sources according to an example embodiment of the present disclosure;

FIG. 3 illustrates a diagram of a dynamic work zone map data system according to an example embodiment of the present disclosure;

FIG. 4 illustrates a flowchart of a method of example embodiments for detecting a road work zone according to an example embodiment of the present disclosure;

FIG. 5 is a flowchart of a method of generating dynamic work zone map data according to an example embodiment of the present disclosure; and

FIG. 6 is a flowchart of a method for aggregating probe data to detect a road work event and generating, from the road work event, a work zone map overlay to inform navigational systems and autonomous vehicles according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present invention for aggregating probe data to detect a road work event and generate, from the road work event, a work zone map overlay to inform navigational systems and autonomous vehicles. In this regard, according to certain embodiments, user interface of a device, such a mobile device or a device affixed to a vehicle, such as to a dashboard or the like, may provide work zone warnings to a user in the form of a map overlay, which may aid the user in navigation or driving in an instance in which the user is traveling by vehicle. According to other embodiments described herein, a road work zone is identified, and a map overlay is generated to indicate on a map where a work zone is defined to inform autonomous or semi-autonomous vehicles of the presence of the work zone such that appropriate precautions may be taken.

A work zone, as described herein, includes an area within which work or construction is being performed that affects, in at least one manner, travel along a road segment. Work or construction need not be actively occurring (e.g., work crews on-site) for a work zone to be considered a work zone. Further, the work or construction that is being performed need not be on a road along which a work zone is defined, as work performed proximate a road segment may affect a road segment sufficiently for the road segment to be identified as having a work zone along the road segment. For example, while work may be performed on a shoulder of a road or even on a building or landscape adjacent to a road segment, the road segment may be impacted by the work. With workers operating adjacent to a road segment, vehicle speeds may be reduced along the road segment to safeguard the workers and increase driver awareness in the area.

Because of the dynamic nature of work zones, and road work events that involve work zones, such work zones may not be adequately represented within map data that is updated periodically. Some work zones occur only during certain times of day, while others can be persistent for months. Further, the way in which road segments are affected by work zones can change frequently. For example, in some instances, work zone speed limits may only be present during such time as workers are present. Work zones may change the number and position of open lanes along a road segment. For these reasons, conventional map data is not well equipped to handle regularly changing work zones and the details thereof that impact traffic flow, routing, and autonomous vehicle control around the area of the work zone.

Provided herein is a method, apparatus, and computer program product to aggregate vehicle data or probe data that includes sensor data collected from sensors of a probe apparatus for road work event detection. Once the road work events have been identified, the affected region can be identified. Using the sensor data of the probe data and underlying map data to determine the affected driving lane and other map attributes that can impact vehicle navigation and autonomous vehicle control. Embodiments provided herein include a map overly of a dynamic work zone that can be generated independently of map data, and the data life period or time-to-live of the work zone can be estimated. The dynamic work zone map data can be delivered as a separate layer from the map data to vehicles or devices through a network to support navigational assistance and to support an autonomous driving strategy when an autonomous driving vehicle approaches the work zone. This added dynamic work zone map data layer can provide information that mitigates confusions over lane changes, temporary lane boundaries, temporary lane markings, etc. A driver of a vehicle using navigational assistance or an autonomous vehicle itself can determine how to proceed based on the dynamic work zone map layer. An autonomous vehicle, for example, may determine that manual driving is necessary such that vehicle control is handed off to a driver. Alternatively, an autonomous vehicle can determine a best path through the work zone and proceed accordingly employing any work zone specific requirements, such as lower speed limits, no passing, etc.

As described herein, example embodiments of the claims may provide for a dynamic work zone map layer. This map layer may be provided to a user via any available device, such as a mobile phone, tablet computer, fixed computer (e.g., desktop computer), or the like. Optionally, the map layer may be provided to autonomous or semi-autonomous vehicle controls to aid the autonomous controls in providing safe travel along a road network where work zones exist. One example embodiment that will be described herein includes a user device of a user traveling in a vehicle. Such a device may be a mobile personal device that a user may use within a vehicle and outside of a vehicle environment, while other devices may include a vehicle navigation system. In some embodiments, the mobile personal device may double as a vehicle navigation system.

While the term “navigation system” is used herein to describe a device used to present map data, traffic data, etc., it is to be appreciated that such a navigation system can be used via a user interface without providing route guidance information. Route guidance is provided in response to a user entering a desired destination, and where a route between the origin or current location of a user and the destination is mapped and provided to the user. A navigation system may be used in the absence of a discrete destination to provide driver assistance and information. For example, as a user travels within a road network, a driver may be made aware of an upcoming work zone such that they can take any necessary precautions, or avoid the area altogether.

In example embodiments, a navigation system user interface may be provided for driver assistance for a user traveling along a network of roadways. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like.

Autonomous and semi-autonomous vehicles are classified according to the Society of Automotive Engineers (SAE) to include six distinct levels of autonomy ranging from Level 0 to Level 5. In Level 0, a vehicle may provide warnings and may momentarily intervene (e.g., anti-lock braking or stability control), but has no sustained vehicle control. Level 1 autonomy includes a “hands on” control, where the driver and the automated system share control of the vehicle. Examples include adaptive cruise control (ACC) where the driver controls steering and the automated system controls speed. The driver must be ready to retake full control at any time with Level 1 autonomy. Level 2 autonomy is “hands off” control, where the system takes full control of the vehicle including accelerating, braking, and steering. The driver must monitor the driving and be prepared to intervene at any time if the automated system fails to respond properly. A driver may be required to maintain hands on a steering wheel in this level of autonomy despite the name as the driver must be ready to intervene when appropriate.

Level 3 vehicle autonomy includes “eyes off” whereby a driver can safely turn their attention away from the driving tasks. For example, a driver of a Level 3 autonomous vehicle can watch a movie or use a mobile device. While the vehicle will handle situations that call for immediate response like emergency braking, the driver must be prepared to intervene within some limited time specified by the manufacturer when called upon to do so. Level 4 autonomous control requires no driver attention for safety and a driver can even leave a driver's seat. Self-driving is supported only in limited spatial areas that may be geofenced or under special circumstances, like traffic jams. Level 5 autonomy is “steering wheel optional” autonomy. This includes true driverless vehicles that do not require a human.

Autonomous and semi-autonomous vehicles may use HD maps and an understanding of the context (e.g., traffic, weather, road construction, etc.) to help navigate and to control a vehicle along its path. In an instance in which a vehicle is subject to complete or partial autonomous control, hazard warnings associated with a work zone defining a geographic area in which a work zone is determined to exist may inform the vehicle enabling appropriate actions to be taken. Those actions may include re-routing to avoid or partially avoid hazardous conditions, or to alter the operational state of the vehicle according to the work zone. Such operational state adjustments may include transitioning from autonomous control to manual control of the vehicle, increasing a sensor refresh rate in anticipation of potential rapid changes in the environment, or the like.

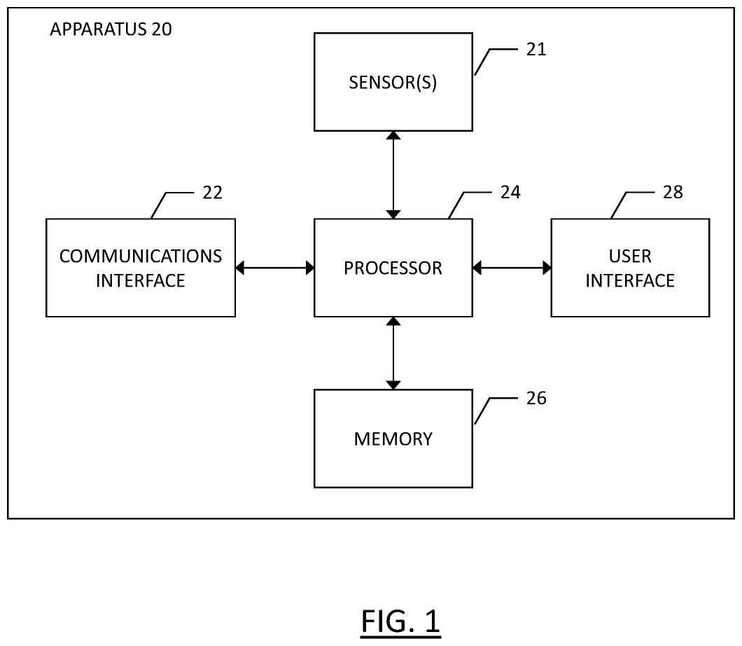

FIG. 1 is a schematic diagram of an example apparatus configured for performing any of the operations described herein. Apparatus 20 is an example embodiment that may be embodied by or associated with any of a variety of computing devices that include or are otherwise associated with a device configured for aggregating probe data to detect a road work event and generating, from the road work event, a work zone map overlay to inform navigational systems and autonomous vehicles. For example, the computing device may be a mobile terminal, such as a personal digital assistant (PDA), mobile telephone, smart phone, personal navigation device, smart watch, tablet computer, camera, or any combination of the aforementioned and other types of voice and text communications systems. Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), Light Distancing and Ranging (LiDAR) sensor, humidity sensor, image capture sensor, precipitation sensor, accelerometer, and/or gyroscope. Any of the sensors may be used to sense information regarding the movement, positioning, or orientation of the device and for determining a weather condition at the location of the device as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like).

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication may alternatively support vehicle to vehicle or vehicle to infrastructure wireless links.

According to certain embodiments, the apparatus 20 may support a mapping or navigation application so as to present maps or otherwise provide navigation or driver assistance. In order to support a mapping application, the computing device may include or otherwise be in communication with a geographic database, such as may be stored in memory device 26. For example, the geographic database includes node data records, road segment or link data records, point of interest (POI) data records, and other data records. More, fewer, or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LIDAR, ultrasonic and/or infrared sensors.

In example embodiments, a user device user interface and/or navigation system user interface may be provided to provide information or driver assistance to a user traveling along a network of roadways. Devices and systems may receive an indication of a current location of the user, and any location based warnings such as work zones associated with the current location of the device and user. While a service provider may be specifically configured to provide location-based information to a user, such a service may be enhanced or improved through cooperation with other service providers that independently determine location based warnings and work zone areas.

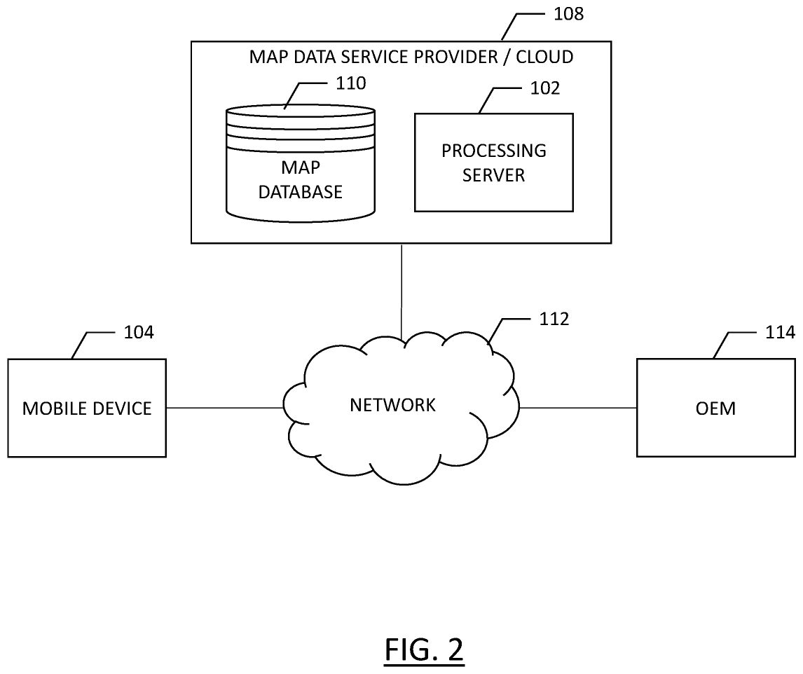

According to example embodiments, map service provider database may be used to provide driver assistance via a navigation system or in conjunction with autonomous vehicle control. FIG. 2 illustrates a communication diagram of an example embodiment of a system for implementing example embodiments described herein using a navigation system and a map data service provider. The illustrated embodiment of FIG. 2 includes a mobile device 104, which may be, for example, the apparatus 20 of FIG. 1, such as a mobile phone, an in-vehicle navigation system, or the like, an original equipment manufacturer (OEM) 114, and a map data service provider or cloud service 108. Each of the mobile device 104, OEM 114, and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The OEM 114 may include a server and a database configured to receive probe data from vehicles or devices corresponding to the OEM. For example, if the OEM is a brand of automobile, each of that manufacturer's automobiles (e.g., mobile device 104) may provide probe data to the OEM 114 for processing. That probe data may be encrypted with a proprietary encryption or encryption that is unique to the OEM. The OEM may be the manufacturer or service provider for a brand of vehicle or a device. For example, a mobile device carried by a user (e.g., driver or occupant) of a vehicle may be of a particular brand or service (e.g., mobile provider), where the OEM may correspond to the particular brand or service. The OEM may optionally include a service provider to which a subscriber subscribes, where the mobile device 104 may be such a subscriber. While depicted as an OEM 114 in FIG. 2, other entities may function in the same manner described herein with respect to the OEM. As such, the OEM 114 illustrated in FIG. 2 is not limited to original equipment manufacturers, but may be any entity participating as described herein with respect to the OEMs.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data or location-based road work event data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LIDAR, can be used to generate map geometries directly or through machine learning as described herein. However, the most ubiquitous form of data that may be available is vehicle data provided by vehicles, such as mobile device 104, as they travel the roads throughout a region. These vehicles or probes may be embodied by mobile device 104 and may provide data to the map data service provider in the form of traffic speed/congestion data, weather information, location, speed, direction, etc.

The map database 110 may be a master map database stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

The OEM 114 may be configured to access the map database 110 via the processing server 102 through, for example, a mapping application, such that the user equipment may provide navigational assistance to a user among other services provided through access to the map data service provider 108. According to some embodiments, the map data service provider 108 may function as the OEM, such as when the map data service provider is a service provider to OEMs to provide map services to vehicles from that OEM. In such an embodiment, map data service provider 108 may or may not be the recipient of vehicle probe data from the vehicles of that manufacturer. Similarly, the map data service provider 108 may provide services to mobile devices, such as a map services provider that may be implemented on a mobile device, such as in a mapping application. According to such an embodiment, the map data service provider 108 may function as the OEM as the map developer receives the probe data from the mobile devices of users as they travel along a road network.

As mentioned above, the map data service provider 108 map database 110 may be a master geographic database, but in alternate embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 1 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments. An embodiment implemented as an ADAS may at least partially control autonomous or semi-autonomous features of a vehicle with the assistance of establishing the vehicle.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Driver assistance information may be communicated to a user via a display, such as a display of user interface 28 of apparatus 20 of FIG. 1. The display may be a display of a mobile phone, or a screen of an in-vehicle navigation system, for example. In the presentation of the driver assistance information to the user it is important that the information is communicated clearly and in an easily understood manner such that a user may quickly understand the information presented. As a user of a navigation system may be driving a vehicle, it is important that the navigation information including driver assistance information is quickly and easily understood, without requiring substantial user interaction should additional information be needed by the driver.

Map information and dynamic content is provided in some embodiments by service providers, such as map data service provider 108 of FIG. 1. These services collect probe data from probe apparatuses embodied by connected vehicles with various configurations of sensor arrays and aggregated the collected probe data to build high definition (HD) maps with road segment resolution down to, in some embodiments, centimeters, for an ADAs system to support autonomously controlled vehicles. The sensor data of the probe data collected from vehicles traveling within the road network includes LiDAR, radar, ultrasonic sensors, cameras, geolocation, etc. Generally, ADAS dynamic content services include real time traffic, hazard warning, road signs, safety cameras, on-street parking, etc. Using backend sensor data from the probe apparatus vehicles and advanced wireless technologies (e.g., 4G and/or 5G or subsequent iterations), autonomous vehicle control can be improved through greater awareness of dynamic environmental factors.

Example embodiments provided herein provide a method of providing an indication of work zones within a map, and more particularly, to a method, apparatus and computer program product for aggregating probe data to detect a road work event and generate, from the road work event, a work zone map overlay to inform navigational systems and autonomous vehicles. Mobile devices, such as mobile device 104 may be associated with a particular service provider (e.g., OEM 114 and/or map data service provider 108) where dynamic information such as work zones and road work events are communicated from that particular service provider to the mobile device, and used by the mobile device to present relevant information on a user interface and/or to inform vehicle automation regarding work zones or areas where a road work event is determined to exist. Individually, these service providers may have limited knowledge of dynamic conditions throughout a road network and may not individually have a complete understanding of a road work event or an associated work zone. Individual service providers typically receive dynamic information reports only from mobile devices affiliated with the respective service provider (e.g., as a subscriber). This limits the dynamic information available to a service provider. The limited information available to each service provider results in different dynamic information including road work events and associated work zones.

Embodiments described herein include a method to generate a work zone map overlay from a road work event to inform navigational systems and autonomous vehicle control. Embodiments aggregate connected vehicle probe data including sensor data from the vehicles to detect road work events. Once the road work events have been identified through the aggregated probe data, the affected region is identified. The affected region defines the work zone associated with the road work event. Using the probe data and sensor data thereof, together with the high definition map data, the affected driving lane(s) and other map attributes that impact driving and autonomous vehicle control in the work zone is defined. An overlay of the dynamic work zone map data can then be generated independent of the underlying high definition map data to provide dynamic information to vehicles traveling within a road network in a manner requiring less bandwidth than comprehensive map data. The overlay of the dynamic work zone map data can further have an estimated life or time to live within which the work zone is present.

According to embodiments, the dynamic work zone map data can be delivered as a separate layer or overlay to vehicles through a network connection (e.g., network 112 of FIG. 2) to support navigational guidance and autonomous driving strategies when an autonomous vehicle approaches the work zone. This dynamic work zone map data can provide information to drivers and vehicles of lane changes, temporary lane boundary closures, temporary lane marking, accident avoidance, etc. In the case of an autonomous vehicle, the autonomous vehicle control may determine that autonomous control is not recommended, and cede control to a driver of the vehicle through the work zone.

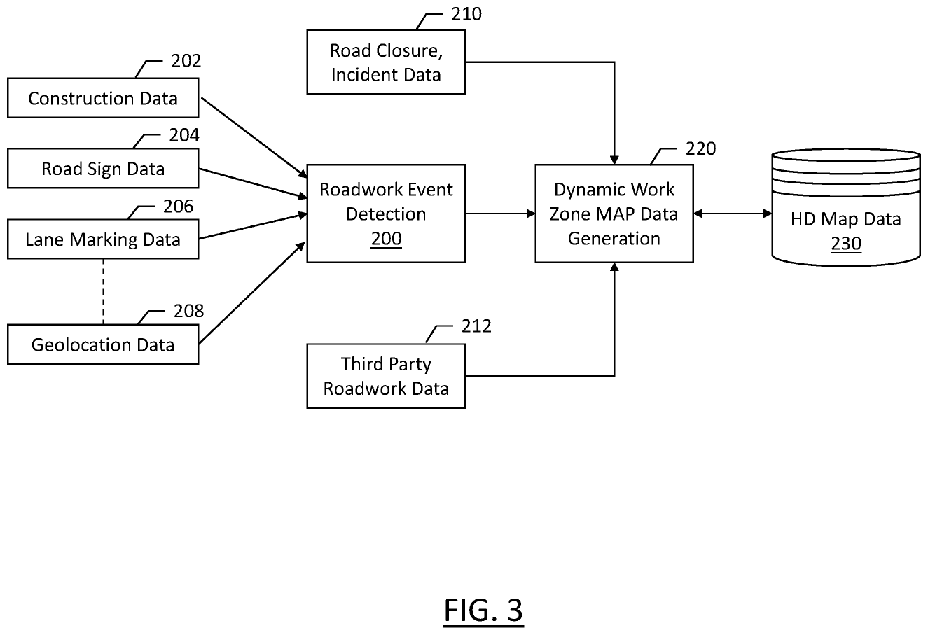

FIG. 3 illustrates a diagram of a dynamic work zone map data system according to an example embodiment of the present disclosure. As shown, connected vehicle sensor data is generated from vehicles traveling withing a road network and includes a variety of sensor data, such as construction data 202 (e.g., temporary barricade detection), road sign data 204, lane marking data 206, and geolocation data 208, among other data collected by vehicles. This data is received by roadwork event detection 200 which may include a software module, hardware module, or the like, and may be embodied, for example, by apparatus 20 of FIG. 1. The roadwork event detection 200 provides information regarding identified roadwork events to dynamic work zone map data generation 220, which may also be embodied by a hardware module, software module, or by apparatus 20, for example. The dynamic work zone map data generation 220 may receive additional information regarding road closure and incident data 210, which may be provided, for example, by a municipality, department of transportation, or other service provider. Further, third party roadwork data 212 may be provided to the dynamic work zone map data generation 220, such as by entities responsible for construction and associated closures or impacts on road segments and lanes thereof. The existing HD map data 230 is used to define road segments and locations within a road network. However, the dynamic work zone map data is generated separately from the HD map data for ease of communicating with lower bandwidth and processing requirements. The dynamic work zone map data that is generated can be used at a vehicle in combination with locally stored map data (e.g., a map database stored at a vehicle) as an overlay to provide dynamic, up-to-date map work zone information without requiring map updates that can be processing and bandwidth intensive.

Probe data from vehicles traveling within a road network can include a variety of sensor data, particularly from autonomous vehicles that are equipped with a high-capability sensor suite that can provide rich sensor information with the probe data. Such sensor data can include an identification of construction presence, construction-related signage, speed limit signs, cones, barricades, lane markings, time stamp, location, worker presence, etc. Dynamic content from vehicles can include weather data, traffic data, incident data, hazard warning data, etc. Probe data including the sensor data can be aggregated, such as by map data service provider 108, and map-matched within the HD map data.

Embodiments provided herein include dynamic service providers using sensor data from probe data to detect a road work zone region. Dynamic service providers ingest third party road work data, and the road work zone region can be identified using probe data and sensor data. HD map data for a specific road work zone region can be retrieved to correlate the work zone with rich map data. Embodiments determine if the dynamic work zone map data needs to be generated using probe data including sensor data to detect if there are lane changes or other map attributes that are affected by the work zone temporally. A dynamic work zone map data layer is either created or if one is existing, updated, based on the HD map data and the sensor data to refine lane boundaries, lane widths, lane nodes, and other features of the road segments affected by the work zone. The dynamic work zone map data is packaged for delivery to vehicles as dynamic content through a network, such as through 4G, 5G, internet, or the like when a vehicle is approaching the work zone, when a work zone exists along a vehicle route, or in an offline backend server mode.

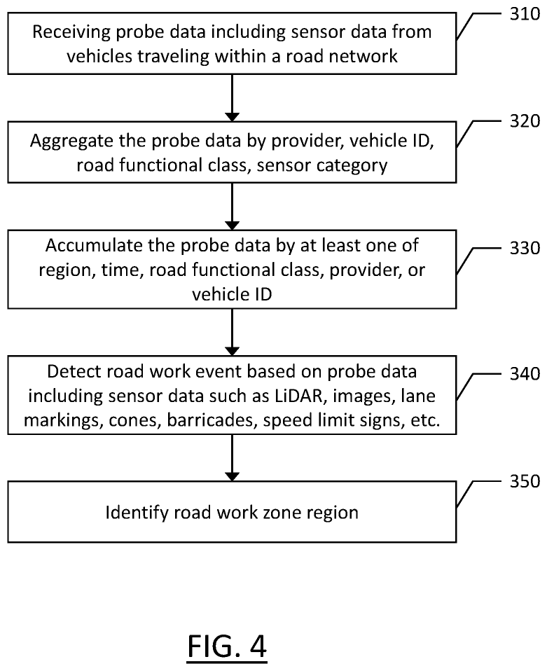

FIG. 4 illustrates a flowchart of a method of example embodiments for detecting a road work zone. Probe data is received at 310, where probe data includes sensor data from vehicles traveling within a road network. The probe data is aggregated at 320, and may be aggregated by a plurality of categories, such as by provider (e.g., OEM, service provider, etc.), vehicle identifier, road functional class, sensor category (e.g., LiDAR, images, etc.). Probe data is accumulated at 330 by at least one of region of the road network, road functional class, provider, or vehicle identifier. At 340 road work events are detected based on the probe data including the sensor data. The road work zone region is identified at 350.

According to example embodiments described herein, the quality or reliability of the road work zone region may be generated to identify the trustworthiness of the road work zone region information. The quality score described herein is computed based on agreement of the presence of the road work zone region at particular locations within the road network. This may be performed based on a number of vehicles providing probe data that is in agreement regarding the work zone region, and any vehicles providing probe data that conflicts with the work zone region. Users and vehicles receiving the road work zone region data can understand the quality of the work zone region and use that quality computation to determine how to use information. For example, if the computed quality is high with respect to a work zone region, the user and/or the vehicle may trust that a work zone region exists within the reported area, and take the appropriate precautions. If the computed quality is low, such as when only one source indicates a work zone region at a location, then the user and/or vehicle can determine if any action is to be taken with respect to the identified work zone region.

Embodiments described herein optionally provide a quality measure that may influence how a work zone region indication is processed by a navigational system or autonomous vehicle control system. In this manner, a user may be presented with an alert to a work zone region and a quality of the data supporting the work zone region. The user may be presented with an option to take action with respect to the work zone region or not. This decision may be influenced by the quality of the data, and a user may optionally take into consideration current context of the vehicle, such as if it is apparent that a work zone region is likely (e.g., if traffic is slowing, if signs exist, etc.). Similarly, an autonomous vehicle may use the quality of information with respect to a work zone region to determine what actions may be taken responsive to the information. A threshold may be set, either manually by a user or by the autonomous vehicle control system, below which no action is taken in response to a low quality work zone region, or above which action may be taken in response to a high quality work zone region. Further, there may be multiple thresholds, where different actions are taken based on the quality of the work zone region information. For example, a work zone region of moderate quality (e.g., between 30% and 70%) may result in some actions taken, while different, more substantial actions may be taken by an autonomous vehicle controller or a user in response to a higher quality of information pertaining to the work zone region.

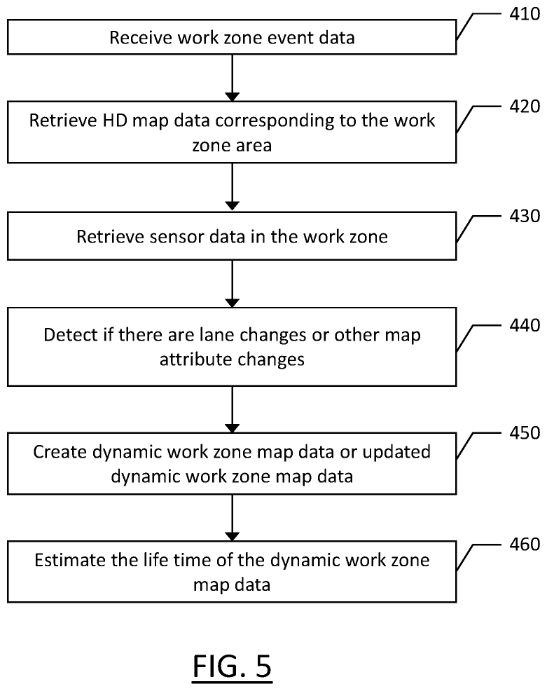

FIG. 5 is a flowchart of a method of generating dynamic work zone map data. Work zone event data is received at 410. HD map data is retrieved for an area corresponding to the work zone area at 420. At 430, probe data including sensor data within the work zone is collected, from which it is determined at 440 if there are any lane changes or other map attribute changes detected, such as reduced speed limits, lane closures, lane shifts, etc. Dynamic work zone map data is created or updated at 450 as an overlay for the HD map data. At 460 the time to live or estimated life time of the dynamic work zone map data is estimated. The method of the flowchart of FIG. 5 depicts the generation of new dynamic work zone map data overlayed with the existing HD map data using probe data and sensor data to support autonomous vehicle control. The sensor data, such as LiDAR data, camera data, lane marking data, road sign data, etc. are used to determine the HD map data attribute that have changed within or proximate the work zone. If there are changes, the new dynamic road work zone data is generated and delivered to vehicles approaching or within the work zone such that the vehicle can take appropriate actions. The time to live of the dynamic road work zone map can be determined or updated based on the sensor data analysis. Map data service providers can determine whether or not to merge the dynamic road work zone map data into the HD map data as there may be frequent changes due to the dynamic nature of road work. It is up to a vehicle in the case of an autonomous vehicle, or a driver in the case of an at least partially manually-driven vehicle to make decisions regarding the work zone when encountering the work zone based on the dynamic work zone overlay data generated and provided herein.

The work zone of example embodiments can be established for one or more segments of road within the road network. The bounds of the work zone can be established based on the probe data and sensor data from the probe apparatus vehicles traveling among the road network. This boundary may include the boundary within which confidence of the work zone presence satisfies at least a minimum value. For example, while some probe apparatuses may identify a work zone as starting at a first location, if most probe apparatuses identify a work zone as starting at a second location, the second location may be used as the start of the work zone boundary based on a higher degree of confidence. Optionally, the probe data and sensor data of some probe apparatuses may be afforded a higher weight, such as vehicles including more accurate sensors or a higher level sensor suite capable of greater detection of an environment of a probe apparatus.

The time to live of work zones of example embodiments described herein can be impacted by a type of event of the road work event. An event such as a traffic accident involving a single vehicle may have a first time to live that is shorter than an event that includes an accident involving multiple vehicles. Further, a road work event including road surface improvement may have a time to live that is considerably longer than that of an accident type event. Still further, a general infrastructure improvement, such as adding traffic lanes, bridge surface repair, the addition or changing of traffic patterns, may each have an even longer time to live. Sensor data collected from probe apparatuses may provide an indication of a road work event type, and the road work event type may indicate a likely time to live of a road work event.

FIGS. 4, 5, and 6 are a flowcharts illustrative of methods according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

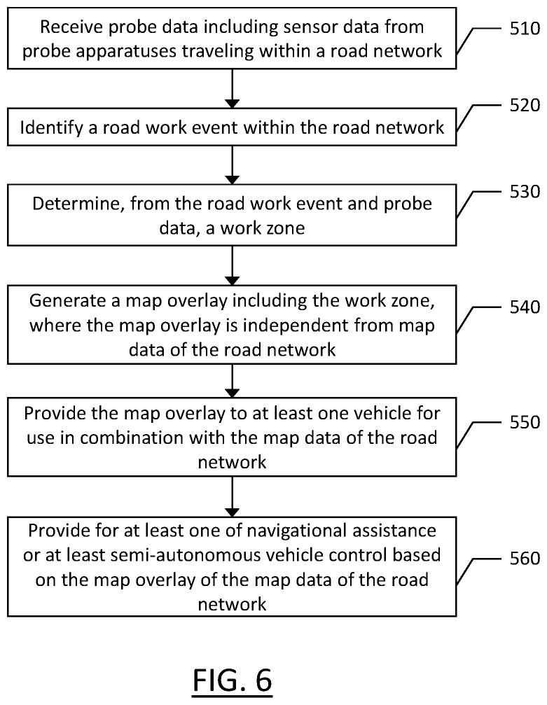

FIG. 6 illustrates a method for aggregating probe data to detect a road work event and generating, from the road work event, a work zone map overlay to inform navigational systems and autonomous vehicles according to an example embodiment of the present disclosure. Probe data is received at 510 including sensor data from probe apparatuses traveling within a road network. Probe apparatuses include, in certain embodiments, sensor-equipped vehicles that provide sensor data together with location information and a timestamp reflecting when the sensor data was collected. A road work event within the road network is identified at 520 from the probe data. Based on the road work event and probe data, a work zone is determined at 530. A map overlay is generated at 540 including the work zone, where the map overlay is independent from map data of the road network. The map overlay is provided to at least one vehicle at 550 for use in combination with the map data of the road network. This overlay may be provided, for example, over a network. At least one of navigational assistance or at least semi-autonomous vehicle control is provided based on the map overlay of the map data of the road network as shown at 560.

In an example embodiment, an apparatus for performing the methods of FIGS. 4, 5, and/or 6 above may comprise a processor (e.g., the processor 24) configured to perform some or each of the operations (310-350, 410-460, and/or 510-560) described above. The processor may, for example, be configured to perform the operations (310-350, 410-460, and/or 510-560) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-350, 410-460, and/or 510-560 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
receive probe data from a plurality of probe apparatuses traveling within a road network;
identify, from the probe data, a road work event within the road network;
determine, from the road work event and the probe data, a work zone;
generate a map overlay including the work zone, wherein the map overlay is independent from map data of the road network;
provide the map overlay to at least one vehicle for use in combination with the map data of the road network; and
provide for at least one of navigational assistance or at least semi-autonomous vehicle control based on the map overlay of the map data of the road network.

2. The apparatus of claim 1, wherein the map overlay is dynamic with the work zone indicating at least one change to road segment information relative to the map data is present.

3. The apparatus of claim 2, wherein the at least one change to road segment information relative to the map data includes a change to at least one of: a number of lanes available on a road segment, a speed limit of a road segment, or lane markings of a road segment.

4. The apparatus of claim 1, wherein the work zone of the map overlay comprises a time to live, wherein the time to live is determined based on an event type of the road work event.

5. The apparatus of claim 4, wherein the event type of the road work event comprises at least one of: a vehicle accident, road surface improvements, or infrastructure changes.

6. The apparatus of claim 1, wherein the apparatus is further caused to:
determine, from the probe data and from map data, one or more affected driving lanes associated with the work zone.

7. The apparatus of claim 6, wherein causing the apparatus to provide for at least one of navigational assistance or at least semi-autonomous vehicle control comprises causing the apparatus to provide at least semi-autonomous vehicle control, wherein the apparatus is further caused to:
identify, from the probe data and map data, map attributes associated with the work zone affecting at least semi-autonomous vehicle control.

8. The apparatus of claim 7, wherein the apparatus is further caused to:
determine, based on the map attributes associated with the work zone affecting at least semi-autonomous vehicle control, that autonomous vehicle control is not recommended; and
cede vehicle control to an operator in response to the apparatus determining that autonomous vehicle control is not recommended.

9. A computer program product comprising at least one non-transitory computer-readable storage medium having computer-executable program code instructions stored therein, the computer-executable program code instructions comprising program code instructions to:
receive probe data from a plurality of probe apparatuses traveling within a road network;
identify, from the probe data, a road work event within the road network;
determine, from the road work event and the probe data, a work zone;
generate a map overlay including the work zone, wherein the map overlay is independent from map data of the road network;
provide the map overlay to at least one vehicle for use in combination with the map data of the road network; and
provide for at least one of navigational assistance or at least semi-autonomous vehicle control based on the map overlay of the map data of the road network.

10. The computer program product of claim 9, wherein the map overlay is dynamic with the work zone indicating at least one change to road segment information relative to the map data is present.

11. The computer program product of claim 10, wherein the at least one change to road segment information relative to the map data includes a change to at least one of: a number of lanes available on a road segment, a speed limit of a road segment, or lane markings of a road segment.

12. The computer program product of claim 9, wherein the work zone of the map overlay comprises a time to live, wherein the time to live is determined based on an event type of the road work event.

13. The computer program product of claim 12, wherein the event type of the road work event comprises at least one of: a vehicle accident, road surface improvements, or infrastructure changes.

14. The computer program product of claim 9, further comprising program code instructions to:
determine, from the probe data and from map data, one or more affected driving lanes associated with the work zone.

15. The computer program product of claim 14, wherein the program code instructions to provide for at least one of navigational assistance or at least semi-autonomous vehicle control comprise program code instructions to provide at least semi-autonomous vehicle control, wherein the apparatus is further caused to:
identify, from the probe data and map data, map attributes associated with the work zone affecting at least semi-autonomous vehicle control.

16. The computer program product of claim 15, further comprising program code instructions to:
determine, based on the map attributes associated with the work zone affecting at least semi-autonomous vehicle control, that autonomous vehicle control is not recommended; and
cede vehicle control to an operator in response to the program code instructions determining that autonomous vehicle control is not recommended.

17. A method comprising:
receiving probe data from a plurality of probe apparatuses traveling within a road network;
identifying, from the probe data, a road work event within the road network;
determining, from the road work event and the probe data, a work zone;
generating a map overlay including the work zone, wherein the map overlay is independent from map data of the road network;
providing the map overlay to at least one vehicle for use in combination with the map data of the road network; and
providing for at least one of navigational assistance or at least semi-autonomous vehicle control based on the map overlay of the map data of the road network.

18. The method of claim 17, wherein the map overlay is dynamic with the work zone indicating at least one change to road segment information relative to the map data is present, wherein the change to road segment information comprises changes to at least one of: a number of lanes available on a road segment, a speed limit of a road segment, or lane markings of a road segment.

19. The method of claim 17, further comprising:
deriving a road detour event based on the work zone to support at least one of navigational assistance or at least semi-autonomous vehicle control

20. The method of claim 17, wherein the apparatus is further caused to:
determine, from the probe data and from map data, one or more affected driving lanes associated with the work zone,
wherein providing for at least one of navigational assistance or at least semi-autonomous vehicle control comprises providing at least semi-autonomous vehicle control, the method further comprising:
identifying, from the probe data and map data, map attributes associated with the work zone affecting at least semi-autonomous vehicle control.
